(19) United States
(12) Patent Application Publication
(10) Pub. No.: US 2021/0373573 A1
(43) Pub. Date: Dec. 2, 2021

(54) Fire Protection Robot, System Comprising the Fire Protection Robot, and Method for Using the Same

(71) Applicant: Minimax GmbH & Co. KG, Bad Oldesloe (DE)

(72) Inventors: Klaus HOFMANN, (DE); Joachim BÖKE, (DE); Kurt LENKEIT, (DE)

(21) Appl. No.: 17/051,167

(22) PCT Filed: May 13, 2019
(86) PCT No.: PCT/EP2019/062166

§ 371 Date: Oct. 27, 2020

(30) Foreign Application Priority Data
May 15, 2018 (DE) 10 2018 111 651.9

(51) Int. Cl. G05D 1/02; A62C 27/00; A62C 37/36; B25J 11/00; B25J 5/00; B25J 9/16

(52) U.S. Cl. CPC G05D 1/0282; A62C 27/00; A62C 37/04; G05D 2201/0207; B25J 5/007; B25J 9/1679; B25J 9/1664; B25J 11/008

(57) ABSTRACT

The invention relates to a fire protection robot (1, 2) for performing a fire protection action. According to the invention, the fire protection robot comprises a communication unit (11) for receiving an instruction signal that represents a target site, and a control unit (10), which is configured to navigate the fire protection robot (1, 2), preferably autonomously, based on the instruction signal, along a navigation path to the target site, wherein the control unit (10) is further configured to detect at least one door (3) along the navigation path and to autonomously open the at least one door (3) in response to the detection.

### PRIORITY CLAIM AND INCORPORATION BY REFERENCE

This application is a 35 U.S.C. § 371 application of International Application No. PCT/EP2019/062166, filed May 13, 2019, which claims the benefit of German Application No. 10 2018 111 651.9, filed May 15, 2018, each of which is incorporated by reference in its entirety.

### TECHNICAL FIELD

The present invention relates to a fire protection robot for performing a fire protection action, a fire protection system comprising the fire protection robot as well as a method for performing a fire protection action.

### BACKGROUND AND SUMMARY OF THE INVENTION

In this context, performing a fire protection action corresponds to performing any type of action that can serve the purpose of (preventative) fire protection. In particular, the term ‘performing a fire protection action’ may correspond to fighting, in particular extinguishing, and/or containing and/or preventing fires, detection and/or verification of (potential) fire events, rescuing persons in the event of a fire and similar.

In the past, it has been common to have such fire protection actions performed by correspondingly trained fire protection personnel. This means that in case of a fire event, additional persons must be brought into the danger zone of the fire in order to first verify and, subsequently, contain and/or fight it and/or rescue uninvolved third parties from the fire.

The progression of a fire event depends on many factors and is therefore only foreseeable to a limited extent. This means that despite the proper training of the fire protection personnel, they are always exposed to certain dangers, especially those that may result from unforeseeable situations. In the event of an unforeseeable event during a fire, the fire protection personnel themselves may fall into danger.

In order to keep the probability of such a situation as low as possible, a fire protection robot, instead of the fire protection personnel, may be used to perform the fire protection action. A fire protection robot is to be understood, in particular, as an unmanned vehicle, especially a robot such as a land robot, a crawling robot and/or a drone that is used for fire protection purposes and can perform one or more fire protection actions.

To perform this fire protection action efficiently, the fire protection robot must navigate as rapidly as possible and via a direct path to the site of the fire event. In this regard, it is problematic that the fire protection robot therefore must be aware of where the fire event is located, on the one hand, and on the other, that the fire protection robot may encounter potential obstacles on the path to the fire event that necessitate a deviation from the direct navigation path. Especially in cases in which the fire event occurs within a building, walls, doors, room furnishings or similar may block the path.

The prior art therefore provides that such fire protection robots are equipped with a device that enables a user to remotely control the fire protection robot. To do so, these fire protection robots comprise a sensor system, one or more cameras, for example, that provide information about the environment of the fire protection robot to the user. The user then decides based on this information how the fire protection robot should be moved/driven and/or which actions the fire protection robot should perform on the path to and at the site of the fire event.

A disadvantage of this solution is that each of these fire protection robots must be controlled by a user. Another disadvantage is that the transmission of the information determined by the sensor system is subject to interference. In particular, in the case of cameras, the images provided to the user can additionally be rendered unusable due to smoke formation.

It is therefore desirable to provide a fire protection robot that does not have these disadvantages. In view of this background, the invention aims at solving the problem of providing a fire protection robot that requires less user interaction to operate and/or control. Moreover, the invention seeks to solve the problem of providing a fire protection robot that can arrive more quickly at the site of the fire event and thereby perform a fire protection action as early as possible, and, thus, more efficiently.

This problem is solved by a fire protection robot for performing a fire protection action, comprising a communication unit for receiving an instruction signal that represents a target site, and a control unit that is configured to navigate the fire protection robot, based on the instruction signal, along a navigation path to the target site, preferably autonomously, wherein the control unit is further configured to detect at least one door along the navigation path and to autonomously open the at least one door as a response to its detection.

The invention is based on the insight that the above-mentioned disadvantages can be overcome by a fire protection robot that works as autonomously as possible. To enable such a highest degree of autonomous operation, it is necessary for the fire protection robot to be supplied with corresponding information that enables the fire protection robot, as autonomously as possible, to determine the site of the fire event, i.e. the target site, and then, based on this determination, to travel to the target site. In this regard, the invention is especially based on the insight that in many fire emergencies, one or more doors must be opened (and potentially closed again) on the path to the target site. For the fire protection robot to work as efficiently and autonomously as possible, the fire protection robot must detect such doors and be able to open them autonomously.

According to the invention, the fire protection robot may be any type of fire protection robot that may be used for the purpose of fire protection. In particular, the fire protection robot may be configured as a verification robot that is capable of verifying a fire event after arriving at the target site. In this case, the fire protection action performed by the fire protection robot comprises a verification action. For verification, the fire protection robot preferably has corresponding sensors that measure a temperature, for example, and therefore may determine a development of warmth and/or heat. Alternatively or in addition, the fire protection robot may also comprise a detection device for detecting fire indicators, such as temperature, temperature gradient, smoke aerosols, electromagnetic radiation, combustion gases, etc.

Alternatively or in addition, the fire protection robot according to the invention may also be configured as an extinguisher robot. In this case, the fire protection action initiated by the fire protection robot (further) comprises an extinguishing action for extinguishing a fire and/or an action for fighting/containing a fire. To this end, the fire protection robot preferably comprises a corresponding extinguishing device for storing and/or supplying and/or dispensing extinguishing agents.

Alternatively or in addition, the fire protection robot may further be configured as a rescue robot for rescuing people located in the area of the fire. In this case, the fire protection action comprises a rescue action of one or more persons. Preferably the fire protection robot comprises corresponding rescue equipment for this purpose. For example, this rescue equipment may comprise blankets, helmets or similar that the persons being rescued may put on while they are being guided away from the fire by the rescue robot. It is especially preferable for the rescue equipment to comprise oxygen masks that the persons being rescued may put on to avoid smoke poisoning and to reduce the risk of suffocation. The fire protection robot may further comprise a transport device for transporting the person being rescued. This has the advantage that even persons who have already suffered significant physical effects, especially those that can no longer walk by themselves, can be transported away and therefore rescued.

According to the invention, the fire protection robot comprises a communication unit. This communication unit is configured, in particular, to receive an input that effects an activation of the fire protection robot. The term activation is to be understood such that through the input the fire protection robot is caused to move in the direction of the target site and, upon arrival at the target site, to initiate a fire protection action. According to the invention, an instruction signal is transmitted to the communication unit as part of the input.

According to the invention, the communication unit may comprise a control panel for inputting the instruction signal, by means of which panel the user may directly input the instruction signal. The fire protection robot is therefore activated by a user input. This not only enables the input of the instruction signal for activating the fire protection robot, but also enables the control of the fire protection robot by the user. Alternatively or in addition, the fire protection robot may also comprise a button for activation, whereby the communication unit does not receive the instruction signal via the control panel but rather from a transmitter, for example, that transferred this signal. To this end, the communication unit may comprise a transmitter/receiver that is in communication with a central device, such as a fire alarm center, and/or separate devices for fire detection, such as one or more fire alarms. The instruction signal is then transmitted by one or more of these devices to the communication unit. In one embodiment, the fire alarm center and/or the one or more fire alarms transmit the instruction signal. In another possible embodiment, the instruction signal received by the transmitter/receiver is transmitted by a remote control that is operated by a user. In this embodiment, the control panel may also be formed as part of the remote control, whereby the remote control enables the user to activate and/or navigate the fire protection robot.

The transmitted instruction signal may comprise a target site indication, in particular. This target site indication specifies to the fire protection robot the target site—i.e. the site of the (potential) fire event—to which the fire protection robot is to move to. To this end, the control unit is preferably configured to derive the target site indication from the instruction signal and to determine the target site in this way. Based on the instruction signal, the control unit may navigate the fire protection robot to the target site along a navigation path.

The navigation path in this regard designates in particular the path to be traveled by the fire protection robot in order to reach the target site from its present site—i.e. the site at which the fire protection robot is located at the time of receiving the instruction signal. Preferably the control unit is configured such that it actively searches, based on the target site indication, for the best navigation path from the start site to the target site. Alternatively or in addition, the instruction signal may also indicate one or more navigation paths. In this case, the fire protection robot may directly follow one of the preset navigation paths. In some embodiments, the fire protection robot considers the preset navigation paths and then, based on this consideration, chooses whether one of the navigation paths is suitable for quickly and reliably guiding the fire protection robot to the target site. If this is not the case, the control unit itself may determine a corresponding navigation path and guide the fire protection robot along it.

To determine the navigation path, the fire protection robot must receive geographical information regarding the region in which it is currently located and through which it has to move. In particular, if the fire event occurs in a building, the fire protection robot must receive information about the building layout, such as hallways and rooms of the building, doors and windows as well as stairs or other ways up. This geographical information, especially the building information, may also be transmitted by means of the instruction signal. Alternatively or in addition, the fire protection robot may be equipped with a memory in which maps of the region in which the fire protection robot is located and through which it has to move toward the target site and/or building plans of the buildings in which the fire protection robot is intended to perform the fire protection action and/or similar is stored as information about the regions. In this case, when the fire protection robot receives an instruction signal that specifies a target site indication of a target site, this saved information is read from the memory and the navigation path to the target site to be reached is determined based on this information. In this case, the fire protection robot is therefore “pre-programmed” for a region to be serviced before the deployment of the fire protection robot, i.e. the geographical information required for this region is loaded onto the fire protection robot when the fire protection robot is set up.

Preferably the control unit is configured to compute the navigation path in the direction of the target site based on the geographical information. Preferably the control unit is further configured to navigate the fire protection robot along the navigation path to be determined in this manner in the direction of the target site.

In many situations, one or more obstacles may be located along the navigation path from the start site to the target site. This is especially the case when the target site is located inside a building, since many buildings have multiple rooms that are respectively separated from one another by doors. In the event of fire, these doors may have been closed. In order to enable the greatest degree of autonomous operation of the fire protection robot, the fire protection robot must be capable of dealing with such obstacles, especially such closed doors along the navigation path. For this purpose, the control unit of the fire protection robot is further configured to detect doors located along the navigation path, especially autonomously, and when a door is detected, to open it autonomously, i.e. independently and without remote control by the user, and then, if applicable, to close them again.

Accordingly, the fire protection robot may comprise, in particular, a key unit that is configured such that it may open the door or the multiple doors located along the navigation path between the start site and target site. For this purpose, the key unit is configured, in particular, to unlock locked doors and/or to open them either manually or by means of a signal. To this end, the control unit may be configured to generate a key signal that effects an unlocking of the door to be opened. Alternatively or in addition, the control unit may be configured to generate a door opening signal in order to open doors electronically. The key signal and/or the door opening signal may be generated based on corresponding information from the instruction signal. Alternatively or in addition, the information necessary for generating the key signal and/or the door opening signal may also be stored within a memory in the fire protection robot. Alternatively or in addition, the key signal and/or the door opening signal may be generated based on a separate signal transmitted in addition to the instruction signal.

In some embodiments, the fire protection robot may alternatively or additionally comprise a mechanical gripper unit that is configured for operating door handles and/or doorknobs of doors that may have already been unlocked. The gripper unit may be activated in response to the instruction signal. The gripper unit is preferably oriented by means of one or more sensors that detect the door handle and/or the doorknob and move the gripper unit correspondingly toward the door handle and/or the doorknob. Alternatively or in addition, the door may also be recognized through a building plan being read from the memory of the fire protection robot, in which are saved the doors and their geometry. In this case, the fire protection robot derives the position of the door and the corresponding door handle and/or doorknob from this saved information.

In some cases, it may be advantageous for the fire protection robot to be able to close the door or the multiple doors again after opening them. This may be especially advantageous in the case of fire protection doors located along the navigation path. In this case, the fire protection robot may open the door in order to drive through it and then close it again in order to ensure the functioning of the fire protection door. In particular, the closing may be effected by means of the mechanical gripper unit, which pulls or pushes the door back into the closed state after the fire protection robot has driven through and may operate the door handle accordingly. Alternatively or in addition, the key unit may be used in cases of a door with a corresponding closing mechanism. The key unit may transmit a door closing signal to a corresponding receiver and/or a corresponding communication unit of the door. The door closing signal may be contained within the key signal or it may be a separate signal.

Preferably, the fire protection robot further comprises a navigation sensor unit that is configured to detect at least one environmental parameter of an environment of the fire protection robot along the navigation path and to transmit it to the control unit, wherein the control unit is configured to detect the at least one door along the navigation path, based on the environmental parameter.

The position of the fire protection robot along the navigation path may vary. This means that the fire protection robot does not always follow an (imaginary) line representing the navigation path, but rather may deviate from this. In such a case, the position of doors along the navigation path may vary relative to the fire protection robot. This may mean that accurate recognition/detection of a door by means of the information stored inside the fire protection robot may no longer take place. In particular, in a case in which one or more doors are arranged along the navigation path, which require precise orientation between the fire protection robot and the opening mechanism of the door, such as doors with a door handle and/or a receiver for a key card, the recognition/detection of the doors by means of saved position information may be insufficient.

To better detect the doors in such a case, the fire protection robot, in a preferred embodiment, further comprises a navigation sensor unit. This navigation sensor unit comprises, in particular, one or more sensors, one or more cameras or similar means that enable the fire protection robot to determine the characteristics of the environment. These characteristics are referred to below as environmental parameters. Preferably the environmental parameters are acquired continuously along the navigation path by the navigation sensor unit. In some embodiments, the acquisition may also occur in the form of discrete values that are determined at predetermined intervals.

The environmental parameters determined in this manner are transmitted from the navigation sensor unit to the control unit. For example, they enable the control unit to determine the width of a hallway through which the fire protection robot is moving and/or the presence and/or geometric dimensions of an obstacle along the navigation path. In particular, the environmental parameters from the control unit may be used to detect doors to be opened along the navigation path. In some embodiments, the environmental parameters may be used to determine the geometric dimensions of the door or doors, especially their width and the position of the opening mechanism. The autonomous execution of the opening procedure by the fire protection robot may thereby take place with higher reliability.

In another preferred embodiment, the control unit is configured to generate a door opening signal for opening the at least one door. In a further development, the instruction signal further represents one or more door opening data, wherein the control unit is configured to generate the door opening signal based on the one or more door opening data. Preferably the control unit is configured to transmit the door opening signal to a control device, especially a building control device, along the navigation path.

In many buildings, the doors are equipped with an electronic opening mechanism. This means the door opening mechanism is connected to a receiver for receiving a door opening signal from a corresponding transmitter. If a user wants to open a door, he activates the transmitter that transmits the door opening signal to the receiver. Receipt of the door opening signal causes the door to open.

To be able to open such doors along the navigation path, the control unit may be further configured to generate a door opening signal. The control unit then uses this door opening signal to open the door or doors along the navigation path. An individual door opening signal may be generated for each door if necessary. Alternatively or in addition, a door opening signal that may be used for all doors along the navigation path may also be generated.

To generate the door opening signal, the control unit needs corresponding information for opening the door or doors. This information, referred to as door opening data, is preferably transmitted as part of the instruction signal. This door opening data comprises, for example, a door opening code for one door or multiple door opening codes for all doors. Preferably, an instruction signal comprises the door opening data, especially the door opening codes, for all doors within the building in which the fire protection robot is deployed.

Upon receipt of the instruction signal by the communication unit, the control unit reads the door opening data, potentially including assignment to their corresponding doors, from the instruction signal and generates, based on the door opening data, a corresponding door opening signal for one or more of the doors along the navigation path. The assignment of the door opening data to the doors may take place by a corresponding indexing of the door opening data.

The door opening signal generated in this way may then be transmitted to the corresponding receiver of the door opening mechanism. Preferably, the control unit is configured to transmit the door opening signal. To this end, the control unit comprises a corresponding transmitter, for example. Alternatively or in addition, the transmitter may also be arranged separately and be in signal communication with the control unit.

Preferably the door opening signal is transmitted to a control device that is arranged along the navigation path. A control device may be especially a building control device, such as a building management system. Alternatively or in addition, the control device may also be a control device for an individual door, e.g., an electronic opening device for the door.

If the control device is a building control device that controls the closing and opening of all or some of the doors of a building, it is preferred for the control unit to transmit the door opening signal by means of the communication unit. The communication unit is usually configured to already be in communicative connection with the building control device in order to receive from it the instruction signal, for example.

In a preferred embodiment of the invention, the fire protection robot further comprises a key unit that is configured to provide a key signal that represents a key code for opening the at least one door.

In a further development of the preceding embodiment, the fire protection robot further comprises a movable arm unit at the end of which the key unit is arranged, wherein the control unit is configured to move the arm unit from a standby position into at least one door opening position, wherein the key element is configured to open the at least one door in the door opening position. According to an alternative or additional further development, the key unit is further configured to generate the key signal based on the instruction signal and/or a door opening signal. It is furthermore preferable for the key unit to be configured as an RFID transceiver that provides a radio key signal upon activation. Alternatively or in addition, the key unit may be configured as an optical signal output unit that provides an optical key signal upon being activated.

In many buildings, the doors to be opened are locked and may only be opened by means of a corresponding key. To open such doors, the fire protection robot may further comprise a key unit that transmits a key signal, which generates a key code. To this end, the fire protection robot preferably receives information about the corresponding key code for the doors to be opened and generates the key signal based on this information. In some embodiments, the fire protection robot derives this information from an internal memory that has been populated corresponding to the buildings to be serviced by the fire protection robot. In some embodiments, the fire protection robot receives the information from an externally transmitted communication signal, such as the instruction signal, for example.

A key unit may be configured in the form of a screen, for example, that displays a barcode or an optical code that functions as a key code. The key code may be read by a corresponding code reader device of the door, especially in the door opening mechanism or in the building control device. If the key code is the correct key code for the respective door, this door is unlocked and/or opened accordingly. In some embodiments, the reading of the correct key code directly results in opening of the door. In some embodiments, the key code only serves to unlock the door and the opening of the door is accomplished in a different way, such as manually or by means of an additional door opening signal.

The screen for displaying the key code may be arranged in the body of the fire protection robot, for example. In this case, the fire protection robot detects, for example, the position of the reader device on the door to be opened and orients itself accordingly, such that the reader device may read the key code displayed on the screen. In some embodiments, the screen may also be arranged on a corresponding bracket of the fire protection robot. This bracket may be movable, in particular. In this case, in response to detecting the reader device, the fire protection robot may move the bracket for the screen such that the reader device may read the key code displayed on it.

Alternatively or in addition, the key unit may also comprise an RFID (radio frequency identification) transmitter that transmits an RFID code for opening the door to a corresponding RFID receiver. In some embodiments, the key unit may comprise a programmable key card. In this case, the fire protection robot is preferably configured to program on its own the key card with a key signal that represents the respective key code. The key card may then be read by a corresponding card reader device on the door or in the building. To this end, the key card may in particular be implemented as a movable bracket that is brought by the fire protection robot in response to a detection of a card reader device into a position in which the card reader device may read the key card.

It is preferable for the key unit to be arranged on a corresponding arm unit. For this purpose, the fire protection robot may comprise one or more movable arm units that may be moved from a standby position into a door opening position and then back again. A standby position here means a position in which the arm unit—and the key unit arranged on it—is arranged as close as possible to the body of the fire protection robot. In some embodiments, the fire protection robot may be configured such that the at least one arm unit may be moved into the body when it is in the standby position.

If the fire protection robot is in motion, the at least one arm unit remains in a standby position. This has the effect that the fire protection robot remains as compact as possible. Thus it may also pass through narrow alleys and may therefore reach even difficult to access points within a building.

A door opening position is understood as the position of the arm unit in which the arm unit is extended in front of the body of the fire protection robot in the direction of a door to be opened. In this position, the arm unit is movable such that it moves the key unit in the direction of a corresponding door opening element. For example, the door opening position is to be understood as that position of the arm unit in which the screen of the key unit is oriented such that the corresponding reader device may read the code shown on it or in which the key card of the key unit is arranged, i.e., “held” by the arm unit, such that the card reader device may read the key card.

The arm unit may detect the corresponding door opening element and/or its position, especially by means of the environmental parameters recorded by the navigation sensor unit. Alternatively or in addition, the fire protection robot may comprise an additional camera that records an image of the door and by means of image processing, identifies the door opening element and its position.

To keep the fire protection robot as flexible as possible and always up-to-date, it is preferable for the fire protection robot to generate the key signal based on information from a signal transmitted to the fire protection robot from an external source. Compared to reading from an internal memory, this avoids the necessity of having to regularly update the memory and thereby prevents a situation from arising in which the fire protection robot is not up-to-date and therefore potentially may not unlock a door in front of the fire protection robot.

It is especially preferable for the key signal to be generated based on the instruction signal and/or the door opening signal. In this connection, “based on” is understood to mean that the instruction signal and/or the door opening signal is used to transmit key data that comprises at least the key codes for the doors to be opened. This key data may be part of the door opening data. It may also be separate information. The fire protection robot, preferably its control unit, reads this data from the instruction signal and/or the door opening signal and generates the key signal using the key data read in this manner, especially the key codes.

Preferably, the control unit generates the key signal. Alternatively the key signal may be generated by the key unit. To this end, preferably the key unit is activated first by transmission of the instruction signal and/or the door opening signal. Then, the necessary key data is read from the instruction signal and/or the door opening signal and, based on the key data, the key signal is generated. Alternatively it is possible for the key signal to be generated in another generation unit separate from the key unit and the control unit, which other generation unit has a communicative connection with the key unit and/or the control unit, and, after generating the key signal, to be transmitted to the key unit.

According to a further development, the movable arm unit comprises at least one key holder for detachable fastening of at least one key.

In some embodiments, the arm unit comprises a bracket, especially a key holder, for fastening an electronic key, preferably a read-only electronic key, such as the above-mentioned key card. This key holder is preferably arranged on the end of the arm unit facing away from the body of the fire protection robot. This enables as precise as possible an orientation of the electronic key relative to the door opening element. Another advantage of this embodiment is that the fire protection robot may be flexibly equipped, potentially by a user, with the necessary electronic keys upon activation. To this end, the key holder preferably comprises one or more bracket elements to accommodate one or more electronic keys.

In some embodiments, the fire protection robot additionally comprises a movable gripper unit, wherein the control unit is configured to move the movable gripper unit from a non-activated position into an activated position, and wherein the movable gripper unit is configured, in the activated position, to activate a door opening element of at least one door.

Some doors cannot be opened electronically, but rather have a door handle, doorknob, door button and/or similar as a door opening element for opening the door. Such door opening elements need to be opened by mechanical actuation. To also open the doors independently in such a case, the fire protection robot can preferably additionally comprise a movable gripper unit. This movable gripper unit can be integrated into the movable arm unit or it can be a separate gripper unit.

When the movable gripper unit is not needed, according to the invention it is brought into a non-activated position. In the non-activated position, the gripper unit is preferably close to the body of the fire protection robot or is retracted into it. If the movable gripper unit is implemented as part of the movable arm unit, the non-activated position of the gripper unit corresponds to the standby position of the arm unit.

To (mechanically) open the door, the gripper unit can be displaced from the non-activated position into an activated position. This means that the gripper unit is moved away from the body of the fire protection robot in the direction of the door to be opened and the gripper unit is brought into a position in which it can actuate the door opening element that has to be operated mechanically. The gripper unit can be correctly oriented in an analogous manner to the orientation of the movable arm unit.

To open the door, the gripper unit can preferably comprise a gripper element that is configured to grip and/or actuate the door opening element. The gripper element is preferably arranged at the end of the gripper unit facing away from the body of the fire protection robot. In the non-activated position, the gripper element is close to the gripper unit or is retracted into it. In the activated position, the gripper element is oriented such that it may operate the door opening element as precisely as possible. In one embodiment, the gripper element is integrated into the key unit and the gripper unit is integrated into the movable arm unit, for example, by the key holder being implemented as a gripper element and the movable arm unit being implemented as a movable gripper unit. In this embodiment, the gripper element may be used, on the one hand, to grip an electronic key such as a key card and to orient it relative to a corresponding reader device as a door opening element, and on the other hand, to grip and/or operate a mechanical door opening element. An advantage of this embodiment is that space is saved due to the double function, such that it is possible to provide a space within the body of the fire protection robot into which the movable arm unit may be completely retracted. As such, the fire protection robot is as compact as possible while navigating along the navigation path to the target site and may better navigate around potential obstacles.

In some embodiments, the fire protection robot is configured to initiate a fire protection action upon reaching the target site. In a further development, the fire protection robot further comprises a fire sensor unit that is configured to detect at least one fire indicator at the target site and to initiate the fire protection action in response to detecting the fire indicator.

The fire protection robot according to the invention should work as autonomously as possible. It is therefore preferable for the fire protection robot to not require any additional user input in order to initiate the respective fire protection action. To this end, the fire protection robot may be configured to initiate a fire protection action immediately upon reaching the target site. Fire protection actions may comprise verifying a fire event, initiating an extinguishing, rescuing persons, especially by putting on oxygen masks and/or transporting persons out of the hazard zone. In some embodiments, the fire protection action is initiated immediately once the fire protection robot registers that it has arrived at the target site.

To prevent the fire protection robot from initiating unnecessary fire protection actions, it is preferable for the fire protection robot to be able to first detect the (potential) fire event, for example, in order to correctly verify it, localize it more precisely and better categorize it and determine its extent. To this end, the fire protection robot may be configured in particular to detect at least one fire indicator at the target site. Possible fire indicators are measured values for smoke density or temperature around the fire event, electromagnetic radiation from flames, concentration of combustion gases like carbon monoxide and carbon dioxide or similar. The fire indicators are preferably detected at the target site. They may also be detected along the navigation path, at predetermined time intervals, for example. To detect the fire indicators, the fire protection robot may especially comprise a fire sensor unit that has one or more sensors for determining fire indicators.

If one or more fire indicators are detected by means of the sensors, the fire protection robot initiates the fire protection action. The fire indicator may be, in particular, a temperature, a smoke density, smoke aerosols, electromagnetic radiation, combustion gases or similar. If one fire indicator is detected, a determination that a limit value is exceeded or not reached and/or a determination of a gradient and/or a change of a fire indicator may occur, in particular. If multiple fire indicators are detected, the time progression of these multiple fire indicators may be determined. Alternatively or in addition, the multiple fire indicators may be used to determine any existing patterns in the values of the fire indicators. By means of this analysis of the fire indicators, their gradient and/or their change and/or development over time and/or pattern, it is possible to determine whether the fire event is an actual fire or whether, although one or more fire indicators are detected, there is no fire, but rather the detection is due to other causes. The detection of the one or more fire indicators enables the fire protection robot to reliably categorize the (potential) fire event and to adapt the fire protection action to be initiated.

The fire indicators detected may, in particular, be used by the fire protection robot, in some circumstances together with the environmental parameters, to determine a maximally efficient fire protection action. For example, it may be derived from the determined fire indicators that the carbon dioxide concentration is especially high in a certain region of the room. It may be further derived from the environmental parameters that the exit in another region of the room is blocked and that the room may only be exited through the region with a high concentration of carbon dioxide. In response to detecting these two aspects, the fire protection robot may plan a rescue action in which a person to be rescued must first receive an oxygen mask and then may be transported away.

In the event of a rescue action as a fire protection action, the fire protection robot should additionally have an option for determining the presence and/or position and/or the condition of the person(s) to be rescued. In particular, these personal parameters make it possible to prioritize which persons should be rescued first, if the rescue of multiple persons is intended. To this end, the fire protection robot may comprise a separate sensor unit for determining personal parameters, such as their life signs, position and similar. Alternatively or in addition, the sensors of the navigation unit or the fire sensor unit may be used to detect the persons.

In some further developments, the fire protection robot further comprises an extinguisher device that is configured to initiate a fire extinguishing action as part of the fire protection action.

According to the invention, a fire protection action may comprise, in particular, a fire extinguishing action. This means that the fire protection robot navigates to the target site, potentially verifies the fire event and/or determines one or more fire indicators at the target site and then initiates a fire extinguishing action as fire protection action. To this end, the fire protection robot comprises an extinguisher device for supplying and/or dispensing extinguishing agent on the fire to be extinguished. The extinguisher device may comprise, in particular, an extinguishing agent supply line and an extinguishing agent tank as well as an extinguishing agent outlet, such as a nozzle. The extinguishing agent outlet is preferably movably arranged on the fire protection robot and may be oriented according to the position of the fire. In some embodiments, the extinguishing agent outlet is arranged on the movable arm unit of the fire protection robot and/or the movable gripper unit. In some embodiments, the extinguisher device comprises a separate movable positioning unit for positioning the extinguishing agent outlet.

The extinguishing agent is conducted from the extinguishing agent tank via the extinguishing agent line to the extinguishing agent outlet. Both the extinguishing agent tank as well as the extinguishing agent line may be integrated into the fire protection robot. Alternatively or in addition, the fire protection robot may also be equipped with an external connection to the extinguishing agent line that makes it possible to externally supply extinguishing agents that may be dispensed via the extinguishing agent outlet of the fire protection robot onto the fire.

In some embodiments, the fire protection robot is configured as a land vehicle, especially a robot vehicle, and/or as an airborne vehicle, especially a drone.

According to the invention, the fire protection robot may be implemented as an unmanned land vehicle. In particular, the fire protection robot may be implemented as a robot vehicle that may move over the ground. The robot vehicle may be moved forward by means of a running gear and corresponding wheels. Alternatively or in addition, the robot vehicle may also be implemented as a crawling robot. In particular, the fire protection robot may comprise motor-driven limbs through which a climbing function of the fire protection robot is provided, in order to enable climbing up walls, for example.

It is especially preferable for a fire protection robot that is to initiate a rescue action as a fire protection action to be implemented as a land vehicle. The embodiment as land vehicle has the advantage that the additional load that might result from transporting away a person being rescued may be selected relatively high and therefore flexibly, whereas an embodiment as airborne vehicle may require a more precise knowledge of the additional load.

In some embodiments, the fire protection robot may be implemented as an airborne vehicle, especially as a drone. This has the advantage that the fire protection robot may better move through a building in which many obstacles, such as parts of rubble or similar are lying along the navigation path, since it may fly over them.

A fire protection robot implemented as an airborne vehicle is especially well suited as an extinguishing and/or verification robot since the fire protection robot may reach the target site very quickly and directly. Moreover, a fire protection robot implemented as an airborne vehicle may be able to access hard to reach sources of the fire, such as those that are high up, and thereby perform the fire protection action more efficiently.

In some embodiments, the fire protection robot may be implemented as a combined airborne vehicle and land vehicle. In this case, the fire protection robot may travel to the target site by flying, in particular, and perform a fire protection action there, such as a verification of a fire event. If a fire event is verified and persons to be rescued are in the vicinity, the fire protection robot may then land and perform a rescue action for these persons, for example, transporting the persons away.

In another aspect, the invention relates to a fire protection system that comprises at least one fire protection robot in accordance with the above-described embodiments, as well as a central device, wherein the communication unit of the fire protection robot receives the instruction signal from a central communication unit of the central device. In one embodiment, the fire protection system further comprises a plurality of fire alarms, wherein each one of the plurality of fire alarms is configured to transmit a fire alarm signal to the central device and/or to the fire protection robot. In another embodiment, the instruction signal is generated based on the fire alarm signal.

A central device of a fire protection system according to the invention preferably comprises a fire alarm center, an extinguishing control panel and/or a combination of the two. Preferably the central device transmits the instruction signal to the fire protection robot in order to activate it. The instruction signal may be transmitted to the fire protection robot in response to a user input, in particular. To this end, the central device may comprise, for example, a control panel and/or a keyboard via which the user input occurs. Alternatively or in addition, the instruction signal may also be transmitted in response to a fire alarm signal transmitted by one or more fire alarms.

To this end, the fire protection system preferably comprises a plurality of fire alarm that are connected to the central device for signal transmission. Alternatively or in addition, the fire alarms may also be in (direct) communicative connection with the fire protection robot.

When one or more of the fire alarms detect a fire, they can generate a corresponding fire alarm signal that is transmitted to the central device. The central device receives the fire alarm signal and generates, based on the fire alarm signal, the instruction signal for transmission to the fire protection robot. Alternatively or in addition, the fire alarms can also directly transmit the fire alarm signal to the fire protection robot, which then on its own generates an instruction signal from the fire alarm signal.

To localize the fire and therefore be able to determine the target site, information must be received from the fire alarms as to where the fire has appeared. Since fire alarms are permanently installed elements, an identification of a fire alarm that is reporting a fire simultaneously enables the fire to be localized. In particular, an identification of multiple fire alarms that are transmitting a fire alarm signal makes it possible to trace the spread of the fire. The target site can be determined based on this identification and the position of the identified fire alarm or the multiple identified fire alarms. In addition, an initial assessment of the fire can be performed.

If the fire protection robot receives the fire alarm signal directly from the fire alarms, the fire alarm signal preferably also makes it possible for the fire protection robot to identify the fire alarm that is sending the signal and thereby to determine the target site and to include it in the instruction signal. To this end, the fire alarm signal can comprise an identification of the reporting fire alarm, in particular. If the fire alarms first transmit the fire alarm signal to the central device, this then generates the instruction signal and, by means of the identification of the fire alarm, includes the target site in the instruction signal. In this case, the fire protection robot receives the information about the target site from the central device.

The central device and the fire protection robot are in communicative connection with one another for transmitting the instruction signal. The communication occurs preferably wirelessly, by means of a radio connection. To this end, both the fire protection robot as well as the central device comprise a respective transmitter/receiver. A central device can communicate with multiple fire protection robots in this way and transmit to each of them a respective instruction signal. The instruction signals can be specific for each fire protection robot. In some embodiments, the central device is in communication with an emergency center. In this case, if the fire protection robot verifies a fire at the target site, it can transmit a corresponding signal to the central device, which then informs the emergency center of the fire.

The fire protection system according to the invention makes use of the advantages and preferred embodiments of the fire protection robot according to the invention. The preferred embodiments and further developments of the fire protection robot are therefore simultaneously preferred embodiments and further developments of the fire protection system, for which reason reference is made to the above descriptions in this regard.

In another aspect, the present invention relates to a method for operating a fire protection robot, comprising the following steps: a) receiving an instruction signal that represents a target site by a communication unit of the fire protection robot; b) navigating, preferably autonomously, the fire protection robot along a navigation path to the target site by a control unit; c) detecting at least one door along the navigation path, and d) autonomously opening the at least one door in response to detecting the at least one door. Preferably step d) further comprises providing a door opening signal. Alternatively or in addition, step d) comprises providing a key signal for autonomous opening of the at least one door. It is further preferable that the method comprises: e) initiating at least one fire protection action at the target site. The initiation of the at least one fire protection action at the target site can especially be performed in response to the detection of at least one fire indicator at the target site. The initiation of the at least one fire protection action can comprise an initiation of a fire extinguishing action.

The method according to the invention makes use of the advantages and preferred embodiments of the fire protection robot according to the invention and the fire protection system according to the invention. The preferred embodiments and further developments of the fire protection robot as well as the fire protection system are therefore simultaneously preferred embodiments and further developments of the method, for which reason reference is made in this regard to the above descriptions.

### BRIEF DESCRIPTION OF THE DRAWINGS

The invention is described in more detail below in reference to the attached figures, based on preferred embodiments. The figures show:

FIG. 1 is a schematic depiction of a fire protection robot for performing a fire protection action according to a first preferred embodiment,

FIG. 2 is a schematic depiction of a fire protection robot for performing a fire protection action according to a second preferred embodiment,

FIG. 3 is a schematic depiction of a fire protection robot for performing a fire protection action according to a third preferred embodiment,

FIG. 4A is a schematic depiction of a fire protection robot for performing a fire protection action that comprises a rescue action,

FIG. 4B is a schematic depiction of a fire protection robot for performing a fire protection action that comprises a fire extinguishing action,

FIG. 5 is a schematic depiction of a fire protection system comprising a fire protection robot and a plurality of fire alarms in a first preferred embodiment,

FIG. 6 is a schematic depiction of a fire protection system comprising a fire protection robot and a plurality of fire alarms in a second preferred embodiment, and

FIG. 7 is a schematic depiction of a fire protection robot for performing a fire protection action according to another preferred embodiment.

### MODE(S) FOR CARRYING OUT THE INVENTION

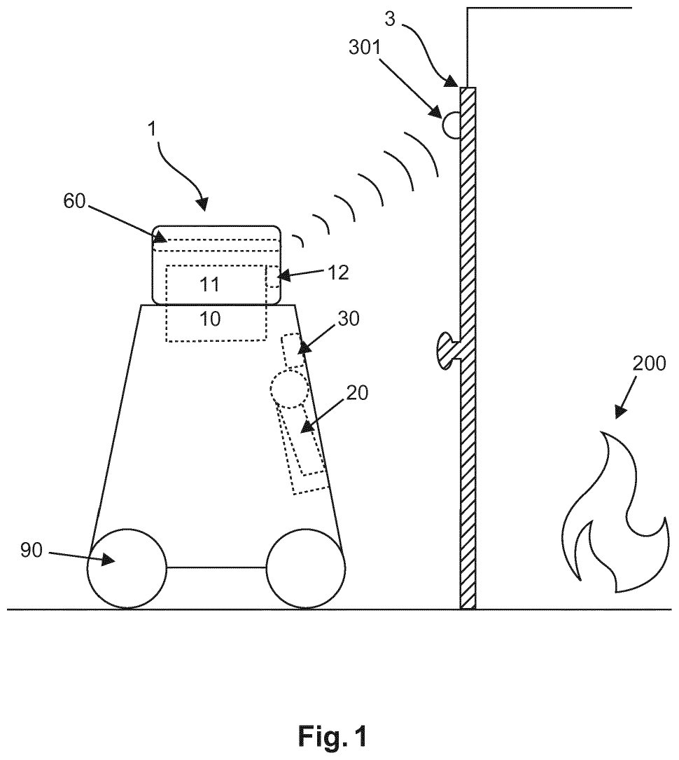

FIG. 1 shows a fire protection robot 1 according to the invention for performing a fire protection action in a first preferred embodiment.

In this embodiment, the fire protection robot 1 is implemented as a land vehicle. In particular, the fire protection robot 1 comprises a drive unit that is implemented as a running gear 90. The fire protection robot 1 further comprises a control unit 10, a communication unit 11, a transmitter 12, a navigation sensor unit 30 and a fire sensor unit 60.

After receiving, via the communication unit 11, an instruction signal that specifies a target site, the fire protection robot 1 is moved by means of the running gear 90 along the navigation path to the target site 200. During the navigation along the navigation path, the fire protection robot 1 uses the navigation sensor unit 30 in order to detect at least one environmental parameter of the environment along the navigation path.

In the example of FIG. 1, the navigation sensor unit 30 detects in particular at least one environmental parameter that indicates an obstacle in the form of the door 3. These environmental parameters may further specify the height and width of the door 3. The environmental parameters are transmitted from the navigation sensor unit 30 to the control unit 10. The control unit 10 detects the door 3 based on the environmental parameters and causes the fire protection robot 1 to autonomously open the door 3.

To this end, the control unit 10 is further configured to generate a door opening signal based on the instruction signal. The instruction signal represents one or more door opening data, in particular one or more door opening codes, that the control unit 10 uses to generate a corresponding door opening signal.

The door 3 comprises a corresponding door opening element 301 that is implemented as a radio signal receiver for receiving the door opening signal. To open the door, the transmitter 12 of the fire protection robot 1 transmits the door opening signal to the door opening element 301. If the door opening signal represents a door opening code that makes it possible to open the door 3, the door 3 is opened by the door opening element 301 in response to receiving the door opening signal, and the fire protection robot 1 may reach the target site 200 through the opened door 3.

At the target site 200, the fire protection robot 1 may then use the fire sensor unit 60 to detect at least one fire indicator and, in response to the detection, initiate a corresponding fire protection action, such as an extinguishing action.

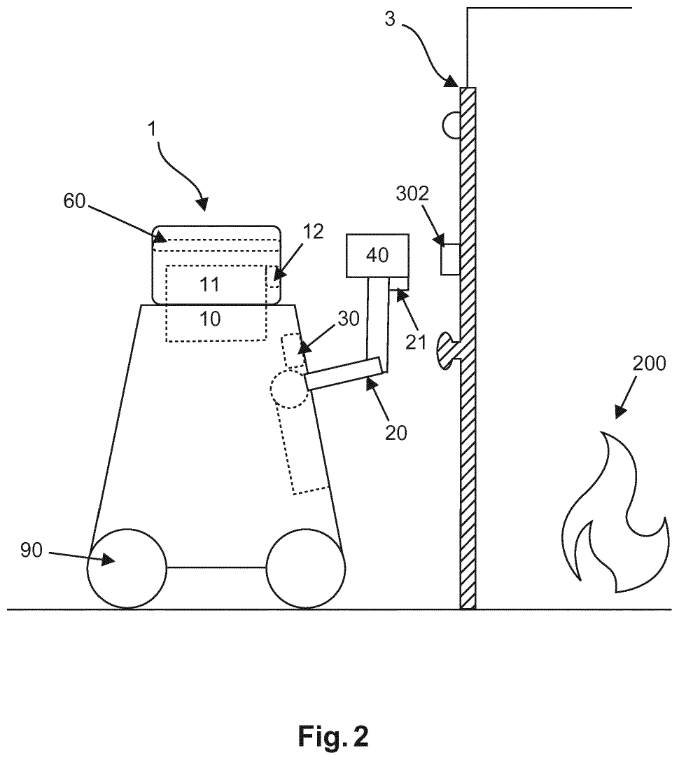

FIG. 2 shows a fire protection robot 1 for performing a fire protection action in a second preferred embodiment of the invention.

The fire protection robot 1 according to FIG. 2 is also implemented as a land vehicle and comprises accordingly a drive unit that is implemented as a running gear 90. Further analogous to the fire protection robot 1 from FIG. 1, the fire protection robot according to FIG. 2 also comprises a control unit 10, a communication unit 11, a transmitter 12, a navigation sensor unit 30 and a fire sensor unit 60. The functioning of these elements of the fire protection robot 1 from FIG. 2 is the same as for the corresponding elements of the fire protection robot 1 from FIG. 1 and is therefore not explained below in more detail.

The fire protection robot 1 additionally comprises a movable arm unit 20, on the end of which facing away from the body of the fire protection robot 1, a key unit 40 is arranged, which further comprises a key holder 21.

As described in connection with FIG. 1, the navigation sensor unit 30 detects at least one environmental parameter that indicates the door 3. This at least one environmental parameter is then transmitted by the navigation sensor unit 30 to the control unit 10, which detects the door 3 based on the at least one environmental parameter, and in response to the detection, initiates an autonomous door opening action. For this door opening action, the control unit 10 generates a door opening signal based on the instruction signal and transmits the door opening signal to the key unit 40.

In the example of FIG. 2, the door opening signal comprises one or more key codes. The key unit 40 is configured to read these key codes from the door opening signal and to generate a key signal based on the door opening signal. The key signal represents the key code for opening the door 3. In the embodiment from FIG. 2, the key unit 40 comprises a screen for displaying a barcode. Here the key signal thus represents the barcode as the key code.

The door 3 comprises a corresponding door opening element 302, which is implemented as a barcode reader device. Once the door 3 is detected and a door opening action is initiated, the control unit 10 causes the movable arm unit 20 to move from a standby position, in which the movable arm unit 20 is arranged close to the body of the fire protection robot 1, into a door opening position. In FIG. 2, the movable arm unit 20 is in the door opening position. This door opening position is, in particular, a position that orients the key unit such that the door opening element 302 may read the barcode displayed on the screen of the key unit 40.

If the key code transmitted by the key signal matches the key code expected by the door opening element 302, the reading of the code effects an unlocking and opening of the door 3. The fire protection robot 1 may reach the target site 200 through the opened door and there initiate a fire protection action.

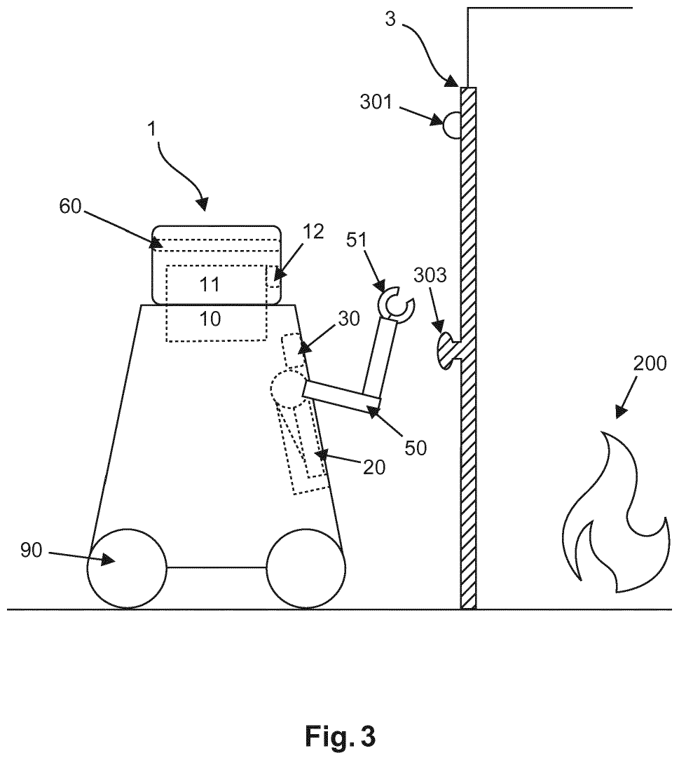

FIG. 3 shows a fire protection robot 1 in a third preferred embodiment of the invention.

The fire protection robot 1 in FIG. 3 is largely analogous to the fire protection robot 1 from FIG. 1 and the fire protection robot 1 from FIG. 2, and it therefore also works in the above-described manner. In contrast to the embodiment from FIGS. 1 and 2, the fire protection robot 1 further comprises a movable gripper unit 50 on which a gripper element 51 is arranged at the end of the gripper unit 50 facing away from the body of the fire protection robot 1. Aside from a door opening element 301 that is implemented as a radio receiver, the door 3 in FIG. 3 also comprises a door opening element 303 in the form of a doorknob 303 that has to be mechanically actuated. In the example of FIG. 3, the door opening action therefore comprises a mechanical opening of the door 3 by means of the doorknob.

In response to the detection of the door 3 by means of the navigation sensor unit 30, as described in connection with FIG. 1, the gripper unit 50 moves from a non-actuating position, in which the gripper unit 50 is arranged close to the body of the fire protection robot 1, into an actuating position. The actuating position is, in particular, a position in which the gripper element 51 of the gripper unit 50 is positioned such that the gripper element 51 may grip the doorknob 303 and then actuate it, by means of a rotational motion, for example. The door is opened by this mechanical actuation of the doorknob 303 and the fire protection robot 1 may reach the target site 200 in order to perform a fire protection action there.

In some embodiments, in addition to the gripper unit 50, the fire protection robot 1 may comprise a key unit 40 that is arranged on a movable arm unit 20 and/or a transmitter 12 for transmitting a door opening signal and/or a key signal. The movable arm unit 20 and the gripper unit 50 may be implemented separately. Alternatively, the gripper unit 50 may also be integrated into the movable arm unit 20. In this case, the gripper element 51 may especially be arranged on an end of the movable arm unit facing away from the body of the fire protection robot 1. For example, in this embodiment, the door 3 may be unlocked by a transmission of a key signal that represents a key code and may then be mechanically opened by means of the gripper element 51. This increases the safety of the closing procedure.

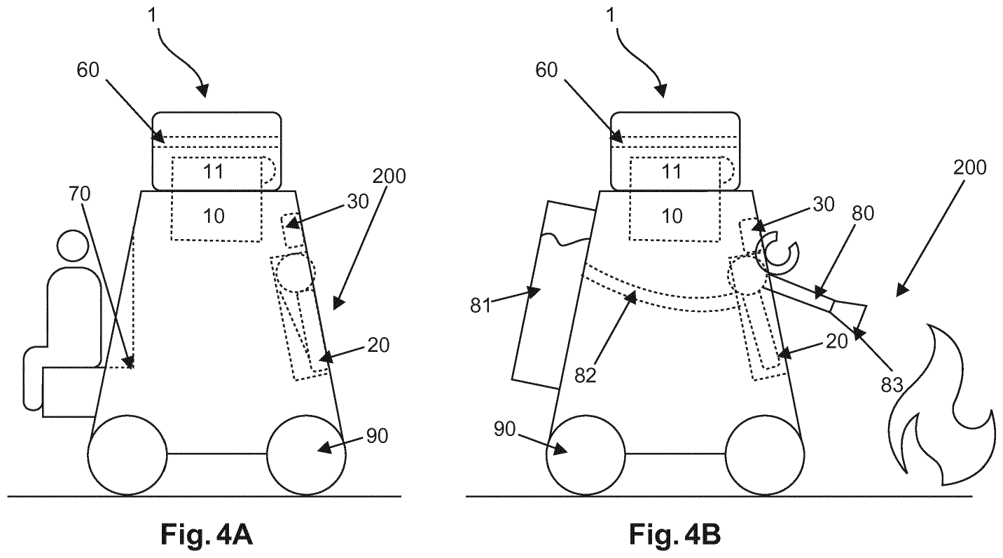

FIGS. 4A and 4B each show in a schematic manner a fire protection robot 1 performing a fire protection action. In FIG. 4A this fire protection action especially comprises a rescue action of a person, which rescue action comprises a transport removing this person from the hazard zone of the fire. To perform this rescue action, the fire protection robot 1 comprises a transport device 70 upon which the person may place themselves for transport away.

In the example of FIG. 4A, upon arrival at the target site 200, the fire protection robot 1 verifies the fire event by means of the fire sensor unit 60 by determining one or more fire indicators. Further the fire protection robot 1 uses the navigation sensor unit 30 to detect the environment of the fire. Here the environmental parameters detected by the navigation sensor unit 30 may indicate that at least one person is in the environment of the fire and must be rescued from there.

In response to detecting the at least one person, the fire protection robot 1 preferably initiates a fire protection action that comprises a rescue action. The rescue action may be initiated directly. Alternatively, the fire protection robot 1 may interrupt a previously initiated fire extinguishing action in order to first rescue present persons.

As such, the fire protection robot 1 moves in the direction of the at least one person and arranges for that person to put on an oxygen mask. The fire protection robot 1 then preferably positions itself such that the person may step onto the transport device 70. While doing so, the fire protection robot 1 may use the environmental parameters to orient itself relative to the person to be rescued such that the person may directly step onto the transport device 70. Preferably, the person indicates, by pressing a button, for example, that they are now on the transport device 70. In some embodiments, the transport device comprises detection means, such as weight sensors, that verify the presence of a person on the transport device 70. In response to the verification that the person is on the transport device 70, the fire protection robot searches for a possible exit and transports the person through it out of the hazard zone of the fire. In doing so, the fire protection robot may determine a safest possible path based on the fire indicators detected by the fire sensor unit and the environmental parameters detected by the navigation sensor unit.

In the example of FIG. 4B, the fire protection action that is initiated at the target site 200 is a fire extinguishing action. To this end, the fire protection robot 1 especially comprises a fire fighting apparatus 80, which in the present case is implemented as an extinguishing device. The fire fighting apparatus 80 comprises an extinguishing agent tank 81, an extinguishing agent line 82 and an extinguishing agent outlet 83 in the form of a nozzle for applying the extinguishing agent to the fire. This means that in the embodiment of FIG. 4B, the extinguishing device 80 is completely arranged on the fire protection robot 1. In other embodiments, however, the extinguishing agent tank may be separately provided.

For navigation to the target site 200, the fire fighting apparatus 80, especially the extinguishing agent outlet 83 located on the front of the fire protection robot 1, may be arranged close to the body of the fire protection robot. In the embodiment of FIG. 4B, during navigation to the target site 200, the extinguishing agent outlet may be arranged on the body in an analogous manner to the movable arm unit 20. This keeps the fire protection robot 1 very compact, which makes navigation easier.

Upon reaching the target site 200, the fire protection robot 1 initiates a fire extinguishing action. To do so, preferably the fire protection robot 1 first detects the fire indicators by means of the fire sensor unit and thereby verifies the fire. After the fire is verified and its position determined, the fire protection robot 1 initiates the fire extinguishing action. The extinguishing agent outlet 83 of the fire fighting apparatus 80 is therefore oriented away from the body of the fire protection robot 1 in the direction of the fire, such that extinguishing agent may reach the fire. In particular, the fire extinguishing action may be controlled by the control unit 10 of the fire protection robot 1.

In some embodiments, the fire protection robot 1 may be configured for both a rescue action as well as a fire extinguishing action, and therefore may represent a combination of what is shown in FIGS. 4A and 4B. In this case, the fire protection robot 1 may first cause the person being rescued to move onto the transport device 70 and put on an oxygen mask, and then use the fire fighting apparatus 80 to detect and fight smaller fires around the fire protection robot 1. This increases the chance of rescuing the person uninjured.

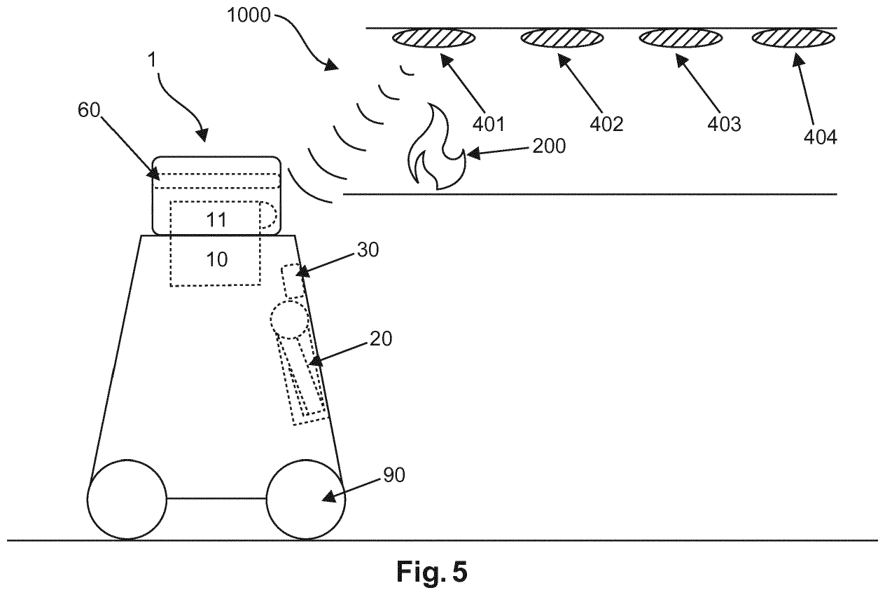

FIG. 5 schematically shows a fire protection system 1000 comprising one or more fire protection robots 1 as described in connection with FIGS. 1 to 3 and a plurality of fire alarms 401, 402, 403, 404. Although only 4 fire alarms 401, 402, 403, 404 are shown in the schematic depiction in FIG. 5, the fire protection system 1000 may comprise more than four, in particular more than 10, in particular more than 50 fire alarms 401, 402, 403, 404. The number of the fire alarms 401, 402, 403, 404 may vary depending on the size of the building and/or the number of rooms in which the fire alarms 401, 402, 403, 404 are installed. There are fire protection systems with several hundred fire alarms 401, 402, 403, 404. The fire protection system may further comprise multiple fire protection robots 1, although only one fire protection robot 1 is shown in FIG. 5.

In the embodiment of FIG. 5, the fire alarms 401, 402, 403, 404 communicate directly with the communication unit 11 of the fire protection robot 1. Here it is preferable for each of the fire alarms 401, 402, 403, 404 to be equipped with a corresponding transmitter for transmitting a fire alarm signal to the communication unit 11 of the fire protection robot 1.

In FIG. 5, the fire protection robot 1 receives, for example, a fire alarm signal from the fire alarm 401 of the plurality of fire alarms. The communication unit 11 of the fire protection robot 1 receives the fire alarm signal and generates an instruction signal based on the fire alarm signal. Here it is preferred that the fire alarm signal comprises an indication for identifying the reporting fire alarm. Alternatively, the identification may also occur by means of a separate signal transmitted by the fire alarm 401 to the communication unit 11. The identification of the fire alarm 401 enables a determination of its (geographical) position within the fire protection system. This determination may be used to determine the target site, i.e. the site of the (potential) fire event. This target site is inserted into the instruction signal during the generation of the instruction signal.

After generating the instruction signal that represents the target site, the former is transmitted to the control unit 10. The control unit 10 uses the target site specification in the instruction signal in order to determine a navigation path to the target site 200. After a navigation path to the target site 200 has been determined, the control unit 10 navigates the fire protection robot 1 along the predetermined navigation path from the start site to the target site 200. If there are obstacles on the path, the fire protection robot 1 may respond to them autonomously. For instance, the fire protection robot 1 may open the doors 3 located along the navigation path or drive around obstacles. If a door 3 cannot be opened or an obstacle cannot be driven around, the control unit 10 is preferably configured to determine a new or updated navigation path that avoids the obstacles that cannot be surmounted. This enables autonomous navigation of the fire protection robot 1 to the target site 200 and simultaneously an equally autonomous initiation of a necessary fire protection action.

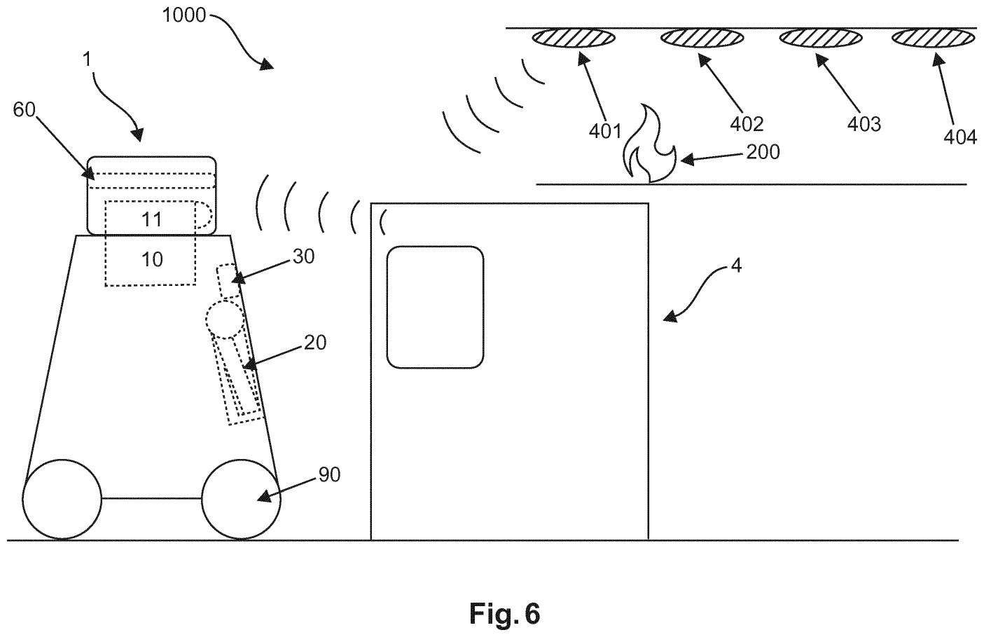

FIG. 6 shows a schematic depiction of a fire protection system 1000 corresponding to a second embodiment of the invention. In this embodiment as well, the fire protection system 1000 comprises one or more fire protection robots 1 and a plurality of fire alarms 401, 402, 403, 404. The fire protection system further comprises a central device 4, which is implemented as a fire alarm center in the embodiment in FIG. 6.

The functioning of the fire alarms 401, 402, 403, 404 from FIG. 6 largely corresponds to the functioning from FIG. 5. However, the fire alarms 401, 402, 403, 404 do not communicate directly with the fire protection robot 1, but rather with the central device 4, which in turn is then in communicative connection with the at least one fire protection robot 1.

In the example of FIG. 6, therefore, the fire alarm 401 transmits a fire alarm signal to the central device 4. In particular, the fire alarm signal contains an indication for identifying the reporting fire alarm 401. Alternatively, the fire alarm 401 may also be identified by a separate signal.

The central device 4 receives the fire alarm signal and generates an instruction signal based on the fire alarm signal. The central device determines the target site 200 by identifying the reporting fire alarm 401 based on its position. The central device 4 inserts a target site identification into the instruction signal and then transmits the instruction signal to the communication unit 11 of the at least one fire protection robot 1. In response to the instruction signal, the control unit 10 of the fire protection robot 1 determines a navigation path to the target site 200 and navigates the fire protection robot 1 accordingly in the direction of the target site 200, wherein it opens doors located on the navigation path as described above. At the target site, the fire protection robot may then initiate a fire protection action.

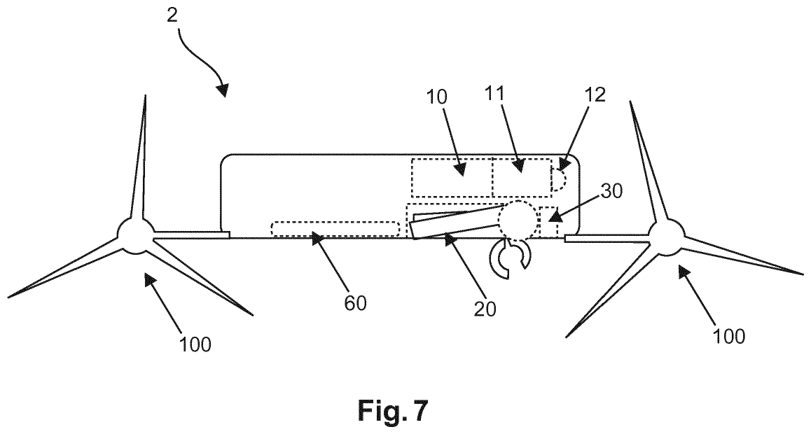

FIG. 7 shows a schematic depiction of a fire protection robot 2 according to another preferred embodiment. In this embodiment, the fire protection robot 2 is implemented as an airborne vehicle. To this end, the fire protection robot 2 comprises a drive unit that is implemented as a propeller 100. The drive unit enables a movement along the horizontal as well as the vertical plane. FIG. 7 only shows the drive unit schematically, whereby not all propellers of the drive unit are illustrated.

The fire protection robot 2 from FIG. 7 works analogously to the fire protection robot 1 from FIGS. 1 to 6. This means the fire protection robot 2 also comprises a control unit 10 and a communication unit 11 for receiving an instruction signal (from the fire alarms 401, 402, 403, 404 and/or the central device 4 and/or from a user input). Based on the instruction signal, the control unit 10 determines a navigation path to the target site 200. Since the fire protection robot 2 is implemented as an airborne vehicle, the navigation path may look different than a navigation path for a land vehicle. This means that in determining the navigation path, the control unit 10 takes into account whether the fire protection robot 2 is a land or airborne vehicle or a combined vehicle.

The control unit 10 is further configured to navigate the fire protection robot 2 along the determined navigation path. If doors to be opened are along the navigation path, they may be detected by the control unit 10. In response to the detection, the control unit 10 then initiates a door opening action. Here the door may be opened in particular by means of the movable arm unit 20, into which a gripper unit 50 is integrated and/or on which a key unit 40 is arranged, as described in connection with FIGS. 2 and 3. The fire protection robot 2 also further comprises at least one transmitter 12 for transmitting a door opening signal and/or a key signal to a corresponding receiver, such as a door 3 and/or a building control apparatus.

### LIST OF UTILIZED REFERENCE NUMBERS

Fire protection robot 1, 2
Door 3
Door opening element 301, 302, 303
Control unit 10
Communication unit 11
Transmitter 12
Movable arm unit 20
Key holder 21
Navigation sensor unit 30
Key unit 40
Movable gripper unit 50
Gripper element 51
Fire sensor unit 60
Transport device 70
Fire fighting apparatus 80
Extinguishing agent tank 81
Extinguishing agent line 82
Extinguishing agent outlet 83
Running gear 90
Propeller 100
Central device 4
Fire alarm 401, 402, 403, 404
Target site 200

1. A fire protection robot for performing a fire protection action, comprising:
a communication unit for receiving an instruction signal that represents a target site; and
a control unit configured to navigate the fire protection robot, based on the instruction signal, along a navigation path to the target site;
wherein the control unit is further configured to detect at least one door along the navigation path and in response to the detecting, to autonomously open the at least one door.

2. The fire protection robot according to claim 1, further comprising:
a navigation sensor unit that is configured to detect at least one environmental parameter of an environment of the fire protection robot along the navigation path and transmit it to the control unit;
wherein the control unit is configured to detect the at least one door along the navigation path based on the environmental parameter.

3. The fire protection robot according to claim 2, whereby the control unit is configured to generate a door opening signal for opening the at least one door.

4. The fire protection robot according to claim 3, wherein the instruction signal further represents one or more door opening data, and wherein the control unit is configured to generate the door opening signal based on the one or more door opening data.

5. The fire protection robot according to claim 3, wherein the control unit is configured to transmit the door opening signal to a control device, along the navigation path.

6. The fire protection robot according to claim 4, further comprising:
a key unit that is configured to provide a key signal that represents a key code for opening the at least one door.

7. The fire protection robot according to claim 6, further comprising:
a movable arm unit, on an end of which the key unit is arranged,
wherein the control unit is configured to move the arm unit from a standby position into at least one door opening position, and
wherein the key unit is configured to open the at least one door in the door opening position.

8. The fire protection robot according to claim 6, wherein the key unit is configured to generate the key signal based on the instruction signal and/or the door opening signal.

9. The fire protection robot according to claim 6, wherein the key unit is configured as an RFID transceiver, which, upon being activated, provides a radio key signal; and/or wherein the key unit is configured as an optical signal output unit, which, upon being activated, provides an optical key signal.

10. The fire protection robot according to claim 7, wherein the movable arm unit comprises at least one key holder for detachably arranging at least one key thereon.

11. The fire protection robot according to claim 1, further comprising:
a movable gripper unit, wherein the control unit is configured to move the movable gripper unit from a non-actuating position into an actuating position; and wherein the movable gripper unit is configured, in the actuating position, to actuate a door opening element of the at least one door.

12. The fire protection robot according to claim 1, wherein the fire protection robot is configured to initiate the fire protection action upon reaching the target site.

13. The fire protection robot according to claim 12, further comprising:
a fire sensor unit that is configured to detect at least one fire indicator at the target site and to initiate the fire protection action in response to the detection of the at least one fire indicator.

14. The fire protection robot according to claim 12, further comprising:
an extinguishing device that is configured to initiate a fire extinguishing action as part of the fire protection action.

15. The fire protection robot according to claim 1, wherein the fire protection robot is configured as at least one of: a land vehicle, a robot vehicle, an airborne vehicle, or a drone.

16. A fire protection system, comprising a fire protection robot according to claim 1 and a central device; wherein the communication unit of the fire protection robot receives the instruction signal from a central communication unit of the central device.

17. The fire protection system according to claim 16, further comprising:
a plurality of fire alarms, wherein each of the plurality of fire alarms is configured to transmit a fire alarm signal to the central device and/or to the fire protection robot.

18. The fire protection system according to claim 17, wherein the instruction signal is generated based on the fire alarm signal.

19. A method for operating a fire protection robot, comprising the following steps:
a) receiving an instruction signal that represents a target site by a communication unit of the fire protection robot;
b) autonomously navigating the fire protection robot by a control unit along a navigation path to the target site;
c) detecting at least one door along the navigation path, and
d) autonomously opening the at least one door in response to the detecting the at least one door.

20. The method according to claim 19, wherein step d) further comprises:
providing a door opening signal and/or a key signal for autonomous opening of the at least one door.

21. The method according to claim 19, further comprising the following step:
e) initiating at least one fire protection action at the target site.

22. The method according to claim 21, wherein the at least one fire protection action is initiated at the target site in response to detection of at least one fire indicator at the target site.

23. The method according to claim 21, wherein the initiating of the at least one fire protection action comprises an initiating of a fire extinguishing action.
